(19) United States
(12) Patent Application Publication
(10) Pub. No.: US 2016/0094878 A1
(43) Pub. Date: Mar. 31, 2016

(54) DEVICE AND METHOD FOR GENERATING METADATA LOG FOR VIDEO DATA

(71) Applicants: SONY CORPORATION, Tokyo (JP); SONY NETWORK ENTERTAINMENT INTERNATIONAL LLC, Los Angeles, CA (US)

(72) Inventors: Charles McCoy, Coronado, CA (US); True Xiong, San Diego, CA (US)

(21) Appl. No.: 14/499,556

(22) Filed: Sep. 29, 2014

(51) Int. Cl. H04N 21/442; H04N 21/422; H04N 21/435

(52) U.S. Cl. CPC H04N 21/44213; H04N 21/435; H04N 21/42221

(57) ABSTRACT

Various aspects of a device and a method for generating metadata logs for video data are disclosed herein. The video data is played back and one or more control signals are received from one or more electronic devices, while the video data is being played back. One or more metadata logs to be associated with the playback of the video data are generated based on the received one or more control signals.

### FIELD

Various embodiments of the disclosure relate to a device and method for generating metadata logs for video data. More specifically, various embodiments of the disclosure relate to a device and method for generating metadata logs for video data based on one or more control signals.

### BACKGROUND

Recent advancements in the field of multimedia technology have made it possible for a video playback device to playback multimedia content, such as digital video data, based on one or more user preferences. Such user preferences may include a desired time duration display, a desired playback behavior, an optimum video data output, a balanced bit depth, and/or a desired configuration setting.

In certain scenarios, during playback on the video playback device, the user may have to provide an input corresponding to a user preference, such as a manual adjustment of configuration settings of external devices. Examples of the manual adjustment of the configuration settings of external devices may include, but are not limited to a selection of one or more speaker systems for a proper surround-sound effect, and/or change the light intensities of various lighting devices of the room where the video playback device is installed. In such scenarios, it may be undesirable for the user to change the configuration settings of the external devices each time the same video data is played back at the video playback device.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A device and method are provided for generating a metadata log for video data as shown in, and described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating a network environment for generating a metadata log for video data, in accordance with an embodiment of the disclosure.

FIG. 2 is a block diagram illustrating a video playback device for generating a metadata log for video data, in accordance with an embodiment of the disclosure.

FIG. 3 is a diagram illustrating an exemplary metadata log, in accordance with an embodiment of the disclosure.

FIG. 4 is a flow chart illustrating exemplary steps for generating and modifying a metadata log for video data and playback of the video data, in accordance with an embodiment of the disclosure.

### DETAILED DESCRIPTION

The following described implementations may be found in a device and method for generating one or more metadata logs for video data. Exemplary aspects of a method for generating a one or more metadata logs for video data may comprise, in a video playback device, receiving one or more control signals associated with one or more electronic devices during playback of video data. Based on the received one or more control signals, one or more metadata logs associated with the playback of the video data may be generated.

In an embodiment, the video playback device may be operable to identify the one or more electronic devices based on the one or more control signals. In an embodiment, the one or more control signals associated with the one or more electronic devices may be infrared (IR) signals. In an embodiment, the video playback device may be operable to update the generated one or more metadata logs based on the received one or more control signals. In an embodiment, the video playback device may be operable to, control a set of electronic devices based on one or more signals transmitted by one or more IR transmitters while the video data is played back. The one or more signals may be transmitted based on at least one metadata log of the one or more metadata logs. In an embodiment, the video playback device may be operable to control playback of the video data based on the one or more metadata logs. In an embodiment, the video playback device may be operable to control playback of another video data based on the one or more metadata logs. In an embodiment, the video playback device may be operable to edit a first of the metadata logs while a video associated with a second of the metadata logs is played back. In an embodiment, the editing comprises creating first of the metadata logs while the video associated with the second of the metadata logs is played back. In an embodiment, the editing comprises modifying first of the metadata logs while the video associated with the second of the metadata logs is played back.

In an embodiment, the video playback device may be operable to determine a user identifier of a user that operates the video playback device. In an embodiment, the video playback device may be operable to record the generated one or more metadata logs that correspond to the user identifier associated with the user. In an embodiment, the generated one or more metadata logs include information corresponding to a user identifier associated with a user of the one or more electronic devices.

In an embodiment, the video playback device may be operable to associate the generated one or more metadata logs with timing information corresponding to the playback of the video data. In an embodiment, the one or more electronic devices are remote controller devices and the received one or more control signals correspond to one or more button press events performed on the remote controller devices.

In an embodiment, the one or more electronic devices may be associated with remote controller devices and the received one or more control signals may correspond to button-press events performed on the remote controller devices. In an embodiment, a graphical representation of the remote controller devices may be generated based on the button-press events performed on the remote controller devices.

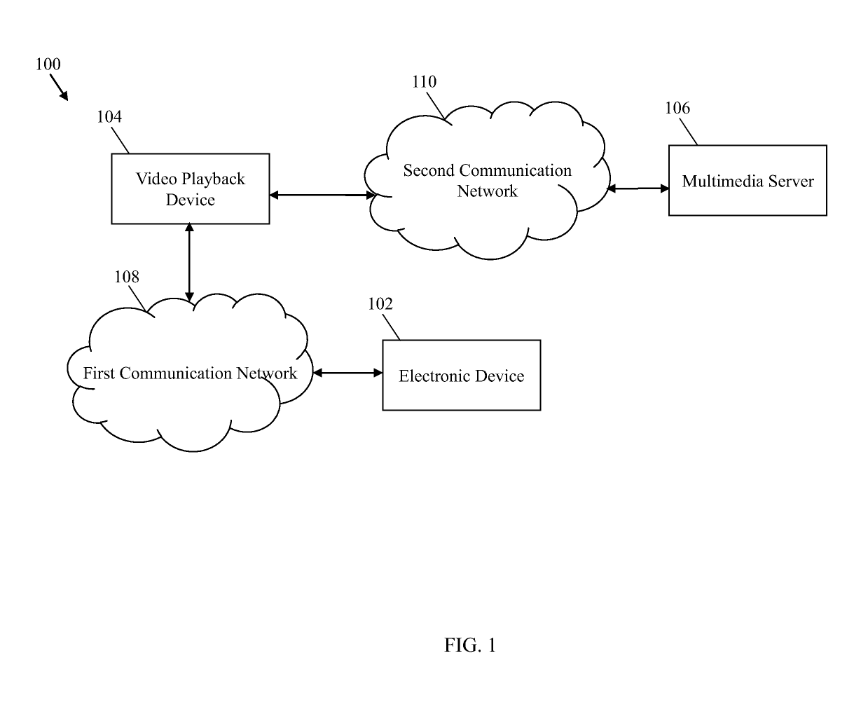

FIG. 1 is a block diagram illustrating a network environment for generating a metadata log for video data, in accordance with an embodiment of the disclosure. With reference to FIG. 1, there is shown a network environment 100. The network environment 100 may comprise one or more electronic devices, such as an electronic device 102, a video playback device 104, a multimedia server 106, a first communication network 108, and a second communication network 110. The video playback device 104 may be communicatively coupled to the multimedia server 106, via the first communication network 108. The video playback device 104 may be further communicatively coupled to the electronic device 102. Although for simplicity, FIG. 1 shows only one electronic device, such as the electronic device 102, communicatively coupled to the video playback device 104, one skilled in the art may appreciate that the disclosed embodiments may be implemented for more than one electronic device, without limiting the scope of the disclosure.

The electronic device 102 may comprise suitable logic, circuitry, interfaces, and/or code that may be operable to receive one or more signals from the video playback device 104, via the first communication network 108. Based on the one or more signals, the electronic device 102 may be controlled by the video playback device 104. The electronic device 102 may be operable to communicate with the video playback device 104, via a wired connection or a wireless connection within the first communication network 108. The wired communication may use any of a plurality of telephone lines, fiber optic cables, microwave transmission, and/or the like. The wireless communication may use any of a plurality of communication standards, protocols and technologies including, but not limited to, Bluetooth, Infrared (IR), Near Field Communication (NFC), Wireless Fidelity (Wi-Fi) (e.g., IEEE 802.11a, IEEE 802.11b, IEEE 802.11g and/or IEEE 802.11n), Ethernet, voice over Internet Protocol (VoIP), Wi-MAX, and/or the like. Examples of the electronic device may include, but are not limited to, a television, a speaker system, a room lighting system, electronically controlled curtains, and/or any other consumer electronics (CE) device.

The video playback device 104 may comprise suitable logic, circuitry, interfaces, and/or code that may be operable to communicate with the electronic device 102, via the first communication network 108. The video playback device 104 may be further operable to communicate with the multimedia server 106, via the second communication network 110. The video playback device 104 may be configured to control the electronic device 102, based on the one or more signals. The video playback device 104 may be operable to download video data from the multimedia server 106, via the first communication network 108. The video playback device 104 may be operable to playback digital video data from media, such as optical discs, and from files of appropriate formats, such as Moving Pictures Experts Group (MPEG).

The multimedia server 106 may comprise suitable logic, circuitry, interfaces, and/or code that may be operable to stream the video data to the video playback device 104. Such video data may include audio-visual content, such as webmail, online retail sales, online auctions, wikis, audio-visual conferences, music albums, movies, live multimedia content sessions, social media, and/or live chat sessions.

The first communication network 108 may comprise a medium through which the electronic device 102 may communicate with the video playback device 104. Examples of the first communication network 108 may include, but are not limited to, a home network, the Internet, a Wireless Fidelity (Wi-Fi) network, an ad-hoc wireless network, a Wireless Local Area Network (WLAN), a Local Area Network (LAN), and/or a telephone line (POTS). Various devices in the network environment 100 may be operable to connect to the first communication network 108, in accordance with various wired and wireless communication protocols, such as: Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

The second communication network 110 may comprise a medium through which the video playback device 104 may communicate with the multimedia server 106. Examples of the second communication network 110 may include, but are not limited to the Internet, a Metropolitan Area Network (MAN), and the like. Various devices in the network environment 100 may be operable to connect to the second communication network 110, in accordance with various wired and wireless communication protocols, such as Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols. In an embodiment, the first communication network 108 and the second communication network 110 may be the same network.

In operation, the video playback device 104 may be operable to receive the video data from the multimedia server 106, via the second communication network 110. In an embodiment, the video playback device 104 may be operable to playback the video data received from the multimedia server 106. In an embodiment, the video playback device 104 may be communicatively coupled to the electronic device 102, via the first communication network 108. In an embodiment, the video playback device 104 may receive one or more control signals from the electronic device 102, via the first communication network 108. In an embodiment, the video playback device 104 may receive one or more control signals from a remote controller associated with the electronic device 102. Based on the received one or more control signals, the video playback device 104 may be operable to generate one or more metadata logs, while the video data is played back on the video playback device 104. In an embodiment, the one or more metadata logs may be provided by a licensed owner of the video data. In an embodiment, the one or more metadata logs may be generated when the video data is recorded. In an embodiment, the one or more metadata logs may be updated and/or modified during the playback of the video data. In an embodiment, the generated one or more metadata logs may be updated and/or modified based on a user input. In an exemplary scenario, the one or more metadata logs may be updated based on a desired ambient lighting set by the user while the video data is recorded. In an embodiment, the one or more metadata logs may be updated based on an orientation of one or more cameras and/or one or more other subjects installed at/near the video playback device 104. In an embodiment, the one or more metadata logs may be updated based on a control signal received from the remote controller to control props and/or special effects of the video data that is played back.

In an embodiment, the one or more metadata logs may be generated when the video data is played back. The one or more metadata logs may be operable to control a later playback of the same video data at the video playback device 104. In an exemplary scenario, when the video data is played back, the one or more signals, based on the one or more metadata logs, may pause the playback of the video data. Later, the one or more signals may resume the playback of the video data. The one or more signals may further pause the playback of the video data for a pre-determined time interval. In such a scenario, the timing of the playback of the metadata logs may not correspond with the timing of the video data being played back. In accordance with the exemplary scenario, the one or more metadata logs may comprise other operations. The other operations may include playing intermission music during the time duration when the playback of the video data is paused. The other operations may further include playing advertisements during the time duration when the playback of the video data is paused. In another exemplary scenario, the volume of the video data may be muted for a particular time duration on playback of an advertisement within the video data. In an embodiment, such an operation may be stored in the one or more metadata logs that may result in an update and/or modification of the one or more metadata logs. In an embodiment, such an operation may be stored in a new metadata log associated with the video data. In instances, where the video data is played back later, based on the one or more metadata logs, the volume of the video data may be muted when the advertisement is played back without user intervention.

In an embodiment, a first of the one or more metadata logs generated by the video playback device 104 may be edited for one video data while a second video data associated with a second of the one or more metadata logs is played back. In an embodiment, the operation of editing may comprise creation of the first of the one or more metadata logs while the second video data associated with the second of the one or more metadata logs is played back. In an embodiment, the operation of editing may comprise modification of the first of the one or more metadata logs while the second video data associated with the second of the one or more metadata logs is played back. In an exemplary scenario, a video data may be played back on the video playback device 104 and may be associated with a corresponding metadata log. A user of the video playback device 104 may perform one or more operations, such as, muting volume of advertisements, changing the light settings of the room, pausing and resuming the playback. The one or more operations may be stored not only in the metadata log of the video data currently being played back, but also in the metadata log of another video data. Thus, when the other video data is played back, based on the corresponding metadata log, the same one or more operations performed during playback of the first video data may be replicated.

In an embodiment, the one or more metadata logs generated and/or modified when the video data is played back, may be operable to control playback of another video data on the video playback device 104. In an exemplary scenario, a user of the video playback device 104 may mute the volume of the video data whenever an advertisement is played back. Such an operation may be stored in the one or more metadata logs and when another video data (different from the video data based on which the one or more metadata logs were generated) is played back, the volume of the other video data may be muted whenever an advertisement is played back within the other video data.

In an embodiment, the video playback device 104 may be operable to identify the electronic device 102, based on the received one or more control signals. In an embodiment, the one or more control signals may be associated with the electronic device 102 based on a user operation. In an embodiment, the user operation may be performed by a user associated with the electronic device 102, via the remote controller associated with the electronic device 102. In an embodiment, the one or more control signals received from the electronic device 102 may be infrared (IR) signals. In an embodiment, the video playback device 104 may be operable to control the electronic device 102, based on the one or more signals. In an embodiment, the video playback device 104 may be operable to control a set of electronic devices, based on the one or more signals. In such an embodiment, the set of electronic devices may comprise the one or more electronic devices and/or other similar electronic devices. In an embodiment, the set of electronic devices that may be controlled during the playback of the video data may not be the same as the one or more electronic devices that had been controlled during the creation of the one or more metadata logs. In such an embodiment, the same one or more signals may control both the set of electronic devices and the one or more electronic devices. In an exemplary scenario, a user replaces a television and home theater with a newer models of the television and the home theater. The user may play back the one or more metadata logs, created for the older models of the television and home theater, for the newer models of the television and home theater receiver. In an embodiment, one or more signals may be transmitted by one or more IR transmitters in the video playback device 104 based on the generated one or more metadata logs. The one or more signals may control the electronic device 102, while the video data is played back at the video playback device 104. In accordance with the exemplary scenario, the room lighting may be adjusted based on the desired ambient lighting retrieved from the updated one or more metadata logs during playback of the recorded video data.

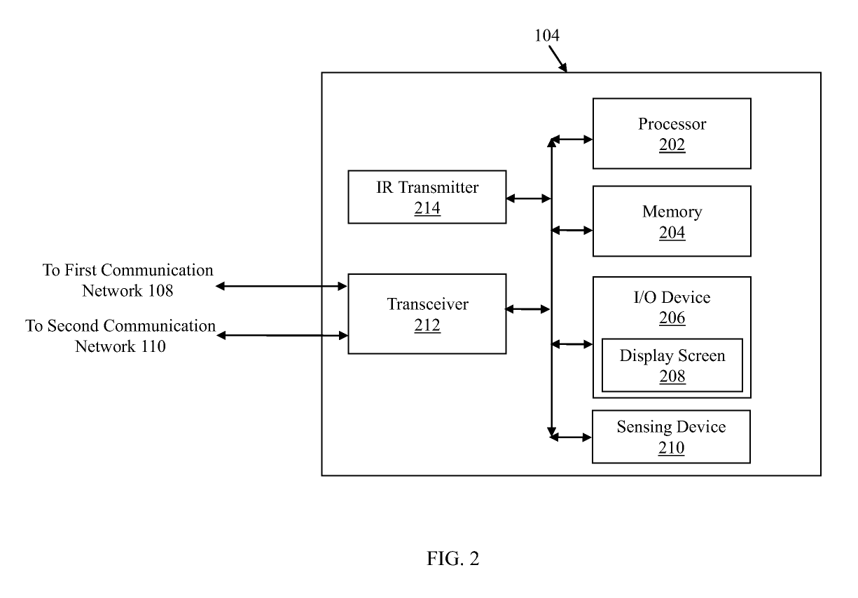

FIG. 2 is a block diagram illustrating a video playback device for generating a metadata log for video data, in accordance with an embodiment of the disclosure. FIG. 2 is explained in conjunction with elements from FIG. 1. With reference to FIG. 2, there is shown the video playback device 104, which may comprise one or more processors, such as a processor 202, a memory 204, an input/output (I/O) device 206, a display screen 208, a sensing device 210, a transceiver 212, and an infrared (IR) transmitter 214. The transceiver 212 may be communicatively coupled to the processor 202, the memory 204, the I/O device 206, the display screen 208, the sensing device 210, and the IR transmitter 214.

The processor 202 may comprise suitable logic, circuitry, interfaces, and/or code that may be operable to execute a set of instructions stored in the memory 204. The processor 202 may be operable to receive the video data from the multimedia server 106, via the second communication network 110. The processor 202 may be further operable to receive one or more control signals from the electronic device 102, via the first communication network 108. The processor 202 may be further operable to generate one or more metadata logs for the video data played back, based on the one or more control signals. The processor 202 may be implemented based on a number of processor technologies known in the art. Examples of the processor 202 may be an X86-based processor, a Reduced Instruction Set Computing (RISC) processor, an Application-Specific Integrated Circuit (ASIC) processor, a Complex Instruction Set Computing (CISC) processor, and/or any other processor.

The memory 204 may comprise suitable logic, circuitry, interfaces, and/or code that may be operable to store a set of instructions, executable by the processor 202. The memory 204 may be operable to store the one or more metadata logs that may be generated by the processor 202 based on the one or more control signals received from the electronic device 102. The memory 204 may be communicatively coupled with a secondary storage device, such as a hard disk, or an external storage device, such as a compact disc (CD). Such a communicative coupling may enable the memory to buffer video data in the secondary storage device or the external storage device. The memory 204 may be operable to store user identifiers for identifying users that operate the electronic device 102. The memory 204 may be operable to store a log editing algorithm to edit the generated one or more metadata logs. The memory 204 may be implemented based on, but not limited to a Random Access Memory (RAM), a Read-Only Memory (ROM), a Hard Disk Drive (HDD), a flash memory, a storage server and/or a Secure Digital (SD) card.

The I/O device 206 may comprise various input and output devices that may be operable to connect to the processor 202. In an embodiment, I/O device 206 may be operable to receive an input from a user associated with the electronic device 102. In an embodiment, I/O device 206 may be operable to render an output to the user. Examples of the input devices may include, but are not limited to a keyboard, a mouse, a joystick, a touch screen, a microphone, a camera, a motion sensor, a light sensor, and/or a docking station. Examples of the output devices may include, but are not limited to, the display screen 208 and/or a speaker.

The display screen 208 may comprise suitable logic, circuitry, interfaces, and/or code that may be operable to render the received video data received from the multimedia server 106. The display screen 208 may be further operable to render one or more features and/or applications of the video playback device 104. The display screen 208 may be further operable to receive an input from the user, via a touch-sensitive screen. Such an input may be received from the user by means of a virtual keypad, a stylus, a touch-based input, and/or a gesture. The display screen 208 may be realized through several known technologies such as, but not limited to Liquid Crystal Display (LCD) display, Light Emitting Diode (LED) display, and/or Organic LED (OLED) display technology.

The sensing device 210 may comprise suitable logic, circuitry, and/or interfaces that may be operable to store a machine code and/or a computer program with at least one code section executable by the processor 202, to receive and respond to a signal when touched or activated. Such a signal may comprise a touch-based input, a touch-less input and/or audio based-based input. In an embodiment, the sensing device 210 may be operable to detect the touch-based input, (such as a pressing a button, turning of a knob, moving of a slider), and the touch-less input, (such as a gesture-based input), provided by the user. In an embodiment, the sensing device 210 may include a microphone operable to detect a voice pattern of the user that corresponds to an audio-based input. In an embodiment, the sensing device 210 may include an Infrared (IR) receiver to detect the one or more control signals, transmitted by the electronic device 102. In an embodiment, the sensing device 210 may include one or more biometric sensors to track one or more biometric characteristics, such as movement of the eyes of the user.

The transceiver 212 may comprise suitable logic, circuitry, interfaces, and/or code that may be operable to receive one or more control signals from the electronic device 102, via the first communication network 108. The transceiver 212 may be further operable to receive the video data from the multimedia server 106, via the second communication network 110. The transceiver 212 may implement known technologies for supporting wired or wireless communication with the first communication network 108 and the second communication network 110. The transceiver 212 may include, but is not limited to an antenna, a radio frequency (RF) transceiver, one or more amplifiers, a tuner, one or more oscillators, a digital signal processor, a coder-decoder (CODEC) chipset, a subscriber identity module (SIM) card, and/or a memory. The transceiver 212 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies including, but not limited to Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The IR transmitter 214 may comprise suitable logic, circuitry, interfaces, and/or code that may be operable to receive one or more instructions from the processor 202 to transmit one or more signals to the electronic device 102. Based on the one or more signals, the processor 202 may be operable to control one or more operations of the electronic device 102. In an embodiment, the IR transmitter 214 may be operable to generate an infrared light in a pre-determined pattern that corresponds to the one or more signals. The infrared light in the pre-determined pattern may be detected by an IR receiver (not shown) of the electronic device 102. The one or more processors (not shown) in the electronic device 102 may be operable to translate the infrared light received in the pre-determined pattern, via the IR receiver, into an instruction. Based on the instruction, the electronic device 102 may perform the one or more operations, via the one or more signals.

In operation, the transceiver 212 may be operable to receive video data from the multimedia server 106, via the second communication network 110. Such video data may include audio-visual content, such as, audio-visual conferences, music albums, movies, and/or live chat sessions. In such an embodiment, the processor 202 may receive the video data from the transceiver 212, and playback the video data on the display screen 208. In an embodiment, the transceiver 212 may receive the video data from a television broadcast station (not shown), as a broadcast signal (such as a television signal). In such an embodiment, a decoder (not shown) may be operable to receive such a broadcast signal from the transceiver 212. The decoder may be operable to decode the received broadcast signal and transmit the decoded broadcast signal to the processor 202. In such an embodiment, the processor 202 may receive the decoded broadcast signals from the decoder and playback the video data on the display screen 208.

In an embodiment, the sensing device 210 may comprise the IR receiver that may receive the one or more control signals. In an embodiment, the one or more control signals may be transmitted by one or more IR emitters of a remote controller associated with the electronic device 102. In an embodiment, the transceiver 212 may be operable to receive the one or more control signals from the electronic device 102, via the first communication network 108. It may be obvious to a person of ordinary skill in the art that the IR emitters may use different protocols, such as RC-5, RC-6 or NEC TC101 protocols, to transmit the one or more control signals to the video playback device 104. Such one or more control signals may correspond to a plurality of light wavelengths in an infrared spectrum. Notwithstanding, the disclosure may not be so limited and the one or more control signals may be transmitted to other electronic devices for performing other such functions. The transceiver 212 may be operable to transmit the one or more control signals to the processor 202.

In an embodiment, the processor 202 may be operable to generate one or more metadata logs that may correspond to the video data that is currently played back by the processor 202. The one or more metadata logs may correspond to the one or more control signals received via the IR receiver. In an embodiment, based on the one or more control signals, one or more operations may be determined that may be performed by the electronic device 102. In an embodiment, based on the one or more control signals, one or more operations may be determined that may be performed by a set of electronic devices. In such an embodiment, the set of electronic devices may comprise the one or more electronic devices and/or other similar electronic devices. The one or more operations may be stored in the one or more metadata logs. The one or more metadata logs may further comprise a user profile of a user that may be associated with the video playback device 104. The user profile may comprise a user identifier, a set of user preferences, recently viewed video data, time duration of one or more operations to be performed during the playback of the video data, favorite video data, and/or the like. In an exemplary scenario, when a movie is played back by the processor 202, a first operation of reduction of the volume of the electronic device 102, such as a television, may be performed by the user. The first operation of reduction of the volume of the television may be performed, based on a button-press input provided by the user, via a first remote controller device associated with the television. The first remote control apparatus may transmit a first control signal to perform the operation of reduction of the volume of the television. Such a first control signal may be detected by the transceiver 212, and transmitted to the processor 202. Similarly, the user may perform a second operation on another electronic device, such as an electronic tube light, via second remote controller device. The second operation may be an operation to switch off the electronic tube light, positioned in front of the display screen 208 of the video playback device 104. The second remote controller device may transmit a second control signal, to perform the operation of switching off the electronic tube light. Such a second control signal may be detected by the transceiver 212, and transmitted to the processor 202.

In an embodiment, video playback device 104 may be operable to receive the video data to be played back and additional metadata logs from another video playback device (not shown), via a single communication channel. In an embodiment, the video playback device 104 may be operable to receive the video data to be played back and the additional metadata logs from the other video playback device, via different communication channels. In such an embodiment, one of the different communication channels may be the Internet. In an embodiment, a broadcast signal of the communication channel, such as the Internet, may include location information of the other video playback device that may transmit the additional metadata logs. In an embodiment, the video playback device 104 may playback the video data based on the additional metadata logs received from the other video playback device, one or more metadata logs retrieved from the memory 204, and/or one or more metadata logs received from other sources.

Based on the first and the second control signals received by the transceiver 212, the processor 202 may generate a metadata log, such as “Log 1”. The metadata log “Log 1” may comprise the details (such as time duration), a plurality of timestamps related to a scene change in the movie played back by the processor 202, the first control signal transmitted by the first remote controller device, the first operation associated with the first control signal, the time of the first operation performed by the user, the second control signal transmitted by the second remote controller device, the second operation associated with the second control signal, and/or the time of the second operation performed by the user. In an embodiment, the processor 202 may store the generated one or more metadata logs, such as “Log 1”, in the memory 204.

In an embodiment, the processor 202 may be operable to playback the video data, such as the movie, again at a later time. In such an embodiment, the processor 202 may retrieve the metadata log, such as the “Log 1”, from the memory 204. The processor 202 may determine the one or more operations, such as the first operation and the second operation, associated with the one or more electronic devices, such as the television and the electronic tube light. The processor 202 may further determine the first and the second control signals, associated with the one or more electronic devices. The processor 202 may further provide one or more instructions to the IR transmitter 214, to transmit the first and the second signals to the one or more electronic devices, such as the television and the electronic tube light. The IR transmitter 214 may transmit the first and the second signals to the television and the electronic tube light, respectively, via the transceiver 212. The transceiver 212 may transmit the first and the second signals to the television and the electronic tube light, respectively, via the first communication network 108.

In an embodiment, the processor 202 may be operable to determine the user profile, from the retrieved metadata log, such as the “Log 1”. Based on the user profile of the user, the processor 202 may determine the first and the second control signals, associated with the one or more electronic devices. The processor 202 may further provide one or more instructions to the IR transmitter 214, to transmit the first and the second signals to the one or more electronic devices, such as the television and the electronic tube-light. Based on the first and the second control signals transmitted by the transceiver 212, the processor 202 may be operable to control the one or more electronic devices, such as the television and the electronic tube-light.

In an embodiment, the video playback device 104 may be operable to control the one or more electronic devices based on the one or more signals transmitted by one or more IR transmitters, such as the IR transmitter 214 while the video data is played back. The one or more signals may be transmitted based on the metadata 306. In an embodiment, the video playback device 104 may be operable to control another one or more electronic devices (not shown) based on the metadata 306 for the same video data playback.

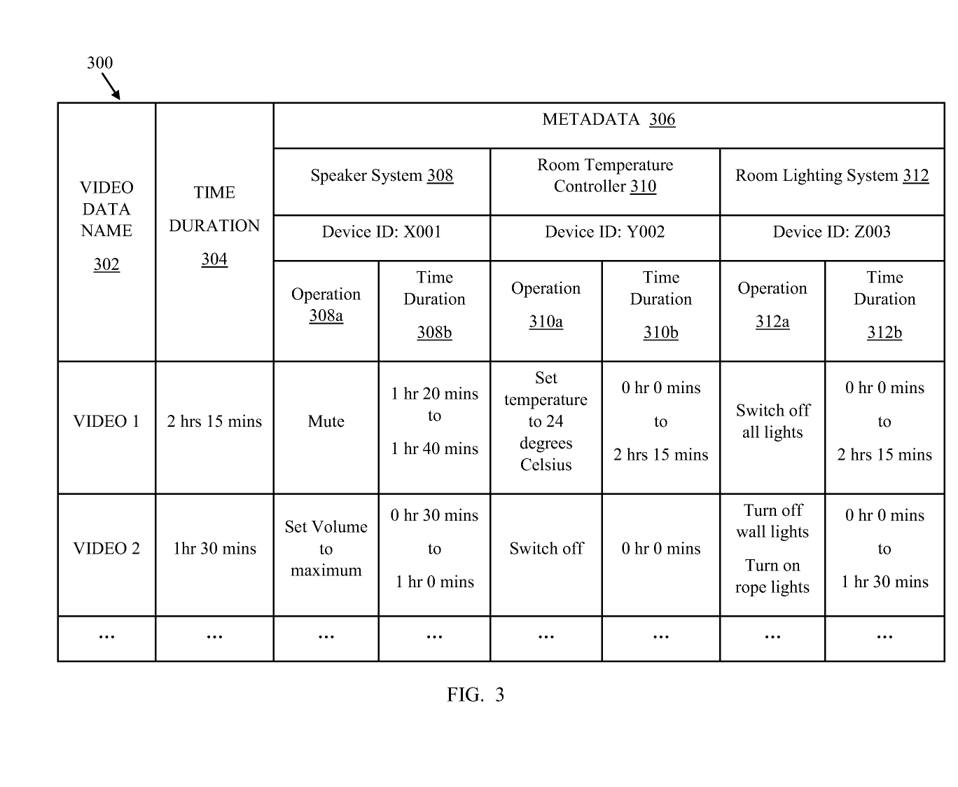

FIG. 3 is a diagram illustrating an exemplary metadata log, in accordance with an embodiment of the disclosure. With reference to FIG. 3, there is shown a metadata log 300. The metadata log 300 is described in conjunction with the diagram of FIG. 1 and FIG. 2. The metadata log 300 may comprise video data name 302, time duration 304 of video data that corresponds to each of the video data name 302, and metadata 306. The metadata 306 may comprise information related to a set of electronic devices, such as a speaker system 308, a room temperature controller 310, and a room lighting system 312. In an embodiment, the set of electronic devices may be a subset of the one or more electronic devices, as described above in FIGS. 1 and 2.

The information may comprise a device identifier (ID) for each of the set of electronic devices. The device ID may include a first device ID, “X001”, for the speaker system 308, a second device ID, “Y001”, for the room temperature controller 310, and a third device ID, “Z001”, for the room lighting system 312. In an embodiment, the metadata 306 may not comprise the device ID of the set of electronic devices. The metadata log 300 may further comprise a first column, such as “Operation 308a”, and a second column, such as “Time Duration 308b”, that correspond to the speaker system 308. The metadata log 300 may also further comprise a third column, such as “Operation 310a”, and a fourth column, such as “Time Duration 310b,” that correspond to the room temperature controller 310. The metadata log 300 may also further comprise a fifth column, such as “Operation 312a”, and a sixth column, such as “Time Duration 312b”, that correspond to the room lighting system 312.

With reference to FIG. 3, the one or more control signals may be received from the set of electronic devices, via a universal remote controller device (not shown). In such an embodiment, the device identifiers, such as “X001”, “Y002”, and “Z003”, may identify the electronic devices that may be controlled by the universal controller device. In an embodiment, the processor 202 may further generate a log of events of the universal remote controller device, such as one or more button-press events, an event when a knob is turned, an event when a slider is moved, an item selection from a menu displayed on a user interface of the universal remote controller device, and/or a physical activity to open or close a curtain where the video playback device 104 is installed. The generated log of the one or more button-press events of the universal remote controller device may be used in one or more remote controller test sessions to playback a series of events to prompt to a UI to a particular point of a test session. In an embodiment, the one or more button-press events of the universal remote controller device may be graphically represented based on the generated log. The graphical representation of the one or more button-press events of the universal remote controller device may be displayed on the display screen 208 of the video playback device 104.

Based on the metadata log 300, the processor 202 may determine one or more operations of the set of electronic devices that may be performed for the designated time period during the playback of video data. For example, the video data name 302, such as “Video 1”, may be played back for the time duration 304, such as “2 hrs 15 mins”. During the time duration 304 for the speaker system 308 with the device ID “X001”, the operation 308a, such as “Mute” may be performed for time duration 308b, such as from “1 hr 20 mins to 1 hr 40 mins”. A start time of the video data name 302, such as “Video 1”, may be set as a reference point for the time duration 308b. In an embodiment, based on the time duration stored in the metadata 306, an additional operation may be performed. In an exemplary scenario, for the time interval “1 hr 20 mins to 1 hr 40 mins”, in addition to the operation “Mute” performed on “Video 1”, an advertisement may be also be played simultaneously. In an embodiment, the metadata 306 may comprise time offset information, with reference to a reference timestamp, to indicate a specific frame of the video data in which a corresponding operation may be performed. In an embodiment, the metadata 306 may comprise a relative time duration for the set of electronic devices to perform a corresponding operation. In an embodiment, the relative time duration for the one or more electronic devices may be determined with respect to the time duration 304 of multiple video data in the metadata log 300. In an exemplary scenario, the relative time duration for the speaker system 308 may be determined with respect to the beginning or the end of the video playback of the video data name 302, such as “Video 1”. In another exemplary scenario, a fade-up operation of the room lighting system 312 may begin 5 minutes before the end of video playback of the video data name 302, such as “Video 2”. In another exemplary scenario, an operation to switch on the room lighting system 312 may be performed before the credits of the video data name 302, such as “Video 2”, have finished playing. In an embodiment, the metadata 306 may comprise a combination of the relative and the absolute time durations, such as “1 minute after 50%” of the time duration 304.

In an embodiment, the metadata log 300 may be edited using a metadata log editing algorithm. In an embodiment, the metadata log editing algorithm may be retrieved from a local memory, such as memory 204, of the video playback device 104. In another embodiment, the metadata log editing algorithm may be received from an external source (not shown) such as an external server or external memory device.

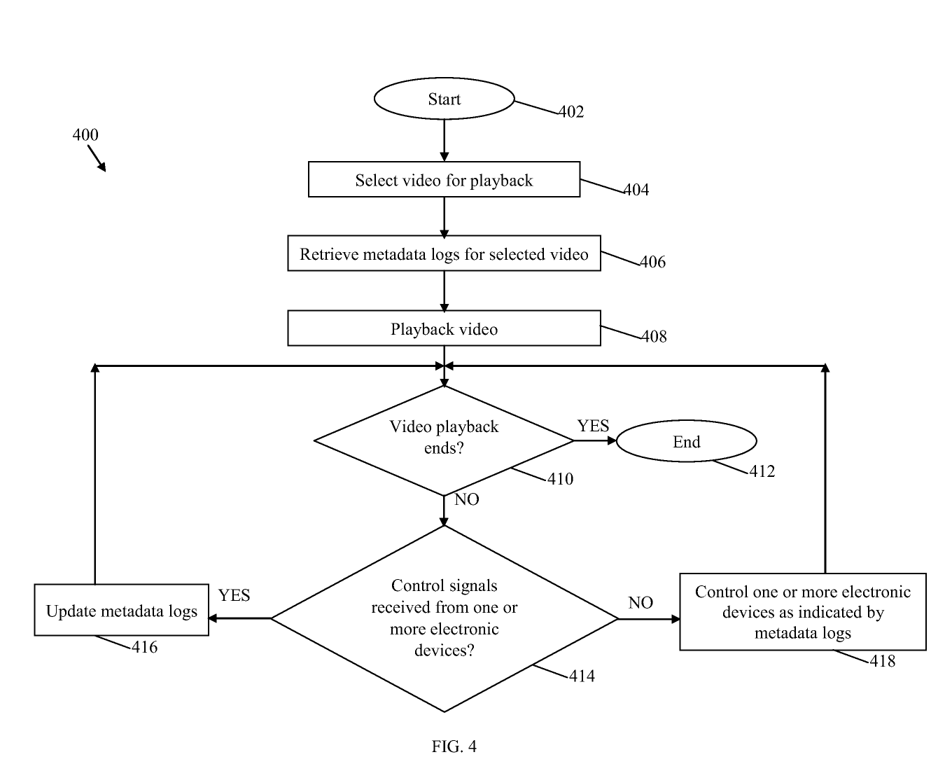

FIG. 4 is a flow chart illustrating exemplary steps for generating and modifying a metadata log for video data and playback of the video data, in accordance with an embodiment of the disclosure. With reference to FIG. 4, there is shown a flow chart 400. The flow chart 400 is described in conjunction with the diagrams of FIG. 1 and FIG. 2.

The method starts at step 402 and proceeds to step 404. At step 404, video data may be selected for playback. The video data may be received from the multimedia server 106, via the second communication network 110.

At step 406, one or more metadata logs may be retrieved from the memory 204 for the selected video data. At step 408, playback of the selected video data may begin. At step 410, it may be determined whether the playback of the video data ends.

In Instances, where it is determined that the playback of the video data ends, the control passes to end step 412. In instances, where it is determined that the playback of the video data has not ended, control passes to step 414.

At step 414, it is determined if one or more control signals are received from one or more electronic devices. The one or more control signals may be associated with one or more operations that may be performed by the one or more electronic devices. In instances where the one or more control signals are received, control passes to step 416. At step 416, the one or more metadata logs associated with the video data may be modified and control passes back to step 410. The modified one or more metadata logs may be stored in the memory 204. In instances, where it is determined that no control signals are received from the one or more electronic devices, control passes to step 418. At step 418, the video playback device 104 may control the one or more electronic devices based on the one or more metadata logs associated with the video data being played back. The control then passes back to step 410.

In accordance with an embodiment of the present disclosure, a video playback device 104 (FIG. 1) may comprise one or more processors, such as the processor 202 (FIG. 2). The processor 202 may be operable to playback video data. The processor 202 may receive one or more control signals associated with one or more electronic devices, hereinafter referred to as the electronic device 102 (FIG. 1), while the video data is played back. The processor 202 may generate one or more metadata logs to be associated with the playback of the video data based on the one or more control signals received from the one or more electronic devices. In accordance with another embodiment of the present disclosure, the processor 202 may be operable to retrieve the one or more metadata logs for the video data selected for playback. The processor 202 may further modify the one or more metadata logs based on the one or more control signals received during the playback of the video data.

Various embodiments of the disclosure may provide a non-transitory computer readable medium and/or storage medium, and/or a non-transitory machine readable medium and/or storage medium having applicable mediums stored thereon, a machine code and/or a computer program having at least one code section executable by a machine and/or a computer. The at least one code section may cause the machine and/or computer to perform the steps comprising played back video data. One or more control signals associated with one or more electronic devices may be received while the video data is played back. One or more metadata logs to be associated with the playback of the video data may be generated based on the one or more control signals received from the one or more electronic devices.

Accordingly, the present disclosure may be realized in hardware, or a combination of hardware and software. The present disclosure may be realized in a centralized fashion in at least one computer system or in a distributed fashion where different elements may be spread across several interconnected computer systems. Any kind of computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) playback in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A video playback device comprising:
one or more processors operable to:
receive one or more control signals associated with one or more electronic devices during playback of video data; and
generate one or more metadata logs to be associated with said playback of said video data based on said received said one or more control signals.

2. The video playback device of claim 1, wherein said one or more control signals are operable to control one or more operations associated with said one or more electronic devices.

3. The video playback device of claim 1, wherein said one or more processors are operable to identify said one or more electronic devices based on said one or more control signals.

4. The video playback device of claim 1, wherein said one or more control signals are infrared (IR) signals.

5. The video playback device of claim 1, wherein said one or more processors are operable to update said one or more metadata logs based on said received said one or more control signals.

6. The video playback device of claim 1, wherein said one or more processors are operable to control a set of electronic devices based on one or more signals transmitted by one or more IR transmitters while said video data is played back, wherein said one or more signals are transmitted based on at least one metadata log of said one or more metadata logs.

7. The video playback device of claim 1, wherein said one or more processors are operable to control playback of said video data based on said one or more metadata logs.

8. The video playback device of claim 1, wherein said one or more processors are operable to control playback of another video data based on said one or more metadata logs.

9. The video playback device of claim 1, wherein said one or more processors are operable to edit a first of said one or more metadata logs while a video associated with a second of said one or more metadata logs is played back.

10. The video playback device of claim 9, wherein said editing comprises creating said first of said one or more metadata logs while said video associated with said second of said one or more metadata logs is played back.

11. The video playback device of claim 10, wherein said editing comprises modifying said first of said one or more metadata logs while said video associated with said second of said one or more metadata logs is played back.

12. The video playback device of claim 1, wherein said one or more processors are operable to:
determine a user identifier of a user operating said video playback device; and
record said one or more metadata logs corresponding to said user identifier associated with said user.

13. The video playback device of claim 1, wherein said generated said one or more metadata logs include information corresponding to a user identifier associated with a user of said one or more electronic devices.

14. The video playback device of claim 1, wherein said one or more processors are operable to associate said one or more metadata logs with timing information corresponding to said playback of said video data.

15. A video playback device comprising:
one or more processors operable to:
retrieve one or more metadata logs for video data selected for playback; and
modify said one or more metadata logs based on one or more control signals received during said playback of said video data.

16. A video playback method comprising:
in a video playback device:
receiving one or more control signals associated with one or more electronic devices during playback of video data; and
generating one or more metadata logs to be associated with said playback of said video data based on said received said one or more control signals.

17. The video playback method of claim 16, further comprising updating said one or more metadata logs based on said one or more control signals.

18. The video playback method of claim 17, further comprising controlling a set of electronic devices based on said one or more control signals in said one or more metadata logs.

19. The video playback method of claim 17, further comprising controlling playback of said video data based on said one or more metadata logs.

20. The video playback method of claim 17, further comprising controlling playback of another video data based on said one or more metadata logs.

21. The video playback method of claim 16, wherein said one or more electronic devices are associated with one or more remote controller devices, wherein said received one or more control signals correspond to one or more button press events performed on said one or more remote controller devices.

22. The video playback method of claim 21, further comprising generating a graphical representation of said one or more remote controller devices based on said one or more button-press events performed on said one or more remote controller devices.
